(19) United States
(12) Patent Application Publication
(10) Pub. No.: US 2010/0332342 A1
(43) Pub. Date: Dec. 30, 2010

(54) SYSTEM AND METHOD FOR BARTERING VIA A GLOBAL COMPUTER NETWORK

(76) Inventors: Mark DeGroot, Red Bank, NJ (US); Hedi Katz, San Rafael, CA (US)

Correspondence Address: MALDJIAN & FALLON LLC, 36 BINGHAM AVENUE, RUMSON, NJ, 07760, US

(21) Appl. No.: 12/823,941

(22) Filed: Jun. 25, 2010

Related U.S. Application Data
(60) Provisional application No. 61/220,778, filed on Jun. 26, 2009.

(51) Int. Cl. G06Q 30/00; G06F 15/16

(52) U.S. Cl. 705/26; 709/205

(57) ABSTRACT

In one embodiment of the present invention, a system for enabling bartering between third parties comprises an administrator comprising a host computer, accessible via a global computer network, the host computer comprising a tangible computer readable medium comprising computer-executable program instructions to implement: allowing a first user to upload a first set of data to the host server regarding a first barterable entry; enabling the first user to assess a point value of the first barterable entry; allowing a second user to upload a second set of data to the host server regarding a second barterable entry; enabling the second user to assess a point value of the second barterable entry; and enabling the first user to barter with the second user, wherein the first user seeks to obtain the second barterable entry in exchange for the first barterable entry.

### CROSS-REFERENCE TO RELATED APPLICATIONS

The present application claims priority to pending U.S. Provisional Patent Application Ser. No. 61/220,778, filed Jun. 26, 2009, entitled “System and Method for Bartering via a Global Computer Network,” the disclosure of which is incorporated herein by reference in its entirety.

### BACKGROUND

1. Field of the Invention

Embodiments of the present invention generally relate to a system for bartering via a global computer network and methods thereof. More specifically, embodiments of the present invention relate to a system for administering a virtual marketplace for the mutual exchange of goods and services and methods thereof.

2. Description of Related Art

Bartering benefits individuals, companies and countries that see a mutual benefit in exchanging goods and services rather than cash. In addition, bartering enables those who are lacking hard currency, or the proper currency (e.g., in a foreign country) to obtain goods and services. It is also considered a green practice, particularly for consumers, as it represents an alternative to throwing things away.

The organized barter exchange industry has allowed many businesses to avoid certain cash outlays and reduce expenses through bartering. The advent of the Internet and sophisticated relational database software programs has further advanced the barter industry's growth. However, despite all the advancements in technology, the systems that are currently available, particularly to consumers, fail to provide an effective virtual marketplace in which parties may barter directly with one another.

Thus, there is a need for a system for bartering via a global computer network and methods thereof.

### SUMMARY

In one embodiment of the present invention, a system for enabling bartering between third parties, the system comprises an administrator comprising a host computer, accessible via a global computer network, the host computer comprising a tangible computer readable medium comprising program instructions, wherein the program instructions are computer-executable to implement allowing a first user to upload a first set of data to the host server regarding a first barterable entry, enabling the first user to assess a point value of the first barterable entry, allowing a second user to upload a second set of data to the host server regarding a second barterable entry, enabling the second user to assess a point value of the second barterable entry, and enabling the first user to barter with the second user, wherein the first user seeks to obtain the second barterable entry in exchange for the first barterable entry, the first user comprising a first computer device, capable of communicating with the host server through the global computer network, and the second user comprising a second computer device, capable of communicating the host server through the global computer network.

In another embodiment of the present invention, a method of enabling bartering between third parties comprises providing a host computer, accessible via a global computer network, allowing a first user comprising a first computer device, capable of communicating with the host server through the global computer network, to upload a first set of data to the host server regarding a first barterable entry, allowing a second user comprising a second computer device, capable of communicating with the host server through the global computer network, to upload a second set of data to the host server regarding a second barterable entry, allowing the first user to determine the point value of the first barterable entry in view of a predetermined standard for the relative worth of a unit of point value, allowing the second user to determine the point value of the second barterable entry in view of a predetermined standard for the relative worth of a unit of point value, and enabling the first user to barter with the second user, wherein the first user seeks to obtain the second barterable entry in exchange for the first barterable entry.

In yet another embodiment, a method of enabling bartering between third parties comprises allowing a first user comprising a first computer device, capable of communicating with a host server through a global computer network, to upload a first set of data to the host server regarding a first barterable entry, allowing a second user comprising a second computer device, capable of communicating with the host server through the global computer network, to upload a second set of data to the host server regarding a second barterable entry, allowing the first user to determine the point value of the first barterable entry in view of a predetermined standard for the relative worth of a unit of point value, allowing the second user to determine the point value of the second barterable entry in view of a predetermined standard for the relative worth of a unit of point value, receiving a request from the first user regarding a desire to obtain the second barterable entry, receiving a response from the second user regarding the request, and enabling the first and second users to barter the first barterable entry for the second barterable entry, respectively.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a block diagram of an exemplary system in accordance with one embodiment of the present invention;

FIG. 2 depicts a block diagram of a general purpose computer system in accordance with one embodiment of the present invention;

FIG. 3 illustrates a block diagram of a database and data sets utilized in accordance with embodiments of the present invention;

FIG. 4 depicts a general flow chart of a method involving various data flow of an administrator, in accordance with embodiments of the present invention; and

FIG. 5 depicts a general flow chart of a method involving various data flow of a user, in accordance with embodiments of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, and components have not been described in detail, so as to not obscure the following description. Furthermore, the examples disclosed herein are for exemplary purposes only and other examples may be employed in lieu of, or in combination with, the examples disclosed.

Embodiments of the present invention generally relate to a system for bartering via a global computer network and methods thereof. More specifically, embodiments of the present invention relate to a system for providing a virtual marketplace for the cashless exchange of goods and services and methods thereof.

As used herein, “bartering” is defined as trade by exchanging one commodity for another. For example, in various embodiments of the present invention, “bartering” may include, but is not limited to, the exchanging of goods for goods, goods for services, services for services, services for goods, services or goods for system points or credits or the like.

As used herein, “barterable entry” is defined as any good, service, credit or point value, or similar value-possessing item, either tangible or virtual, excluding U.S. or foreign government-backed currency, that a person or entity may recognize as having a value.

As used herein, “point value” is defined as a virtual currency, having a limited role within the virtual marketplace disclosed herein, and having no external significance outside of the boundaries of such virtual marketplace.

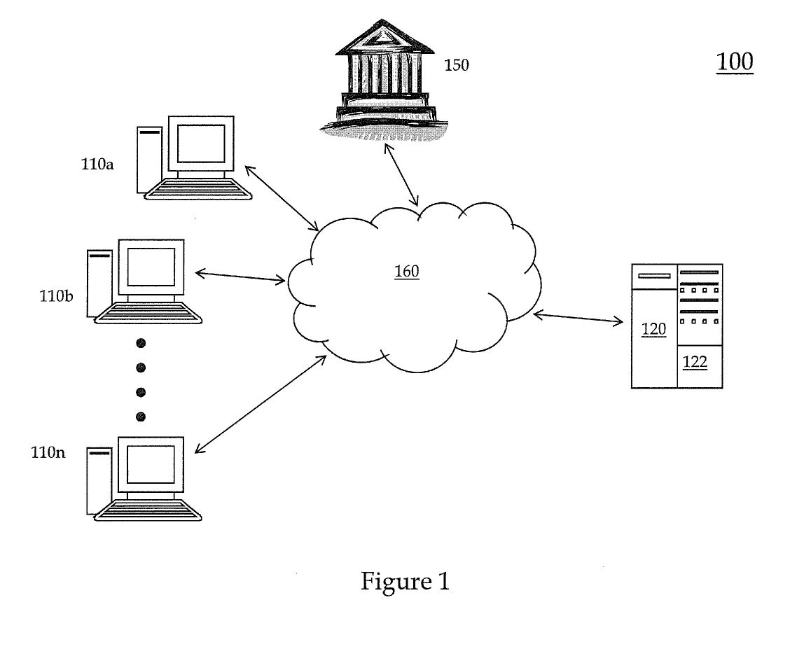

FIG. 1 depicts a block diagram of an exemplary system in accordance with one embodiment of the present invention. The system 100 generally includes at least a first customer 110a, also referred to herein as an end user or client. The system 100 may additionally include at least a second customer 110b, and additional customers, up to customer 110n, where n represents any number of customers practical for operation of embodiments of the present invention. The system 100 further comprises an administrator or host 120, i.e., an organization, company or individual who controls, designs and is generally responsible for implementing and/or facilitating each of the methods disclosed herein.

As is common in network-based business models, the administrator 120 may also comprise a web administrator, responsible for providing and maintaining a website or interactive portal through which all of the customers 110 or users of the system 100 may interact and execute the methodology and functionality disclosed in the embodiments disclosed herein.

The network 160 may comprise any network suitable for embodiments of the present invention. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G and 4G telecommunication networks, wireless office telephone systems (WOTS) and/or wireless local area networks (WLANs), including, Bluetooth and/or IEEE 802.11 WLANs, wireless personal area networks (WPANs), wireless metropolitan area networks (WMANs) and the like; virtual local area networks (VLANs) and/or communication links, such as Universal Serial Bus (USB) links; parallel port links, Firewire links, RS-232 links, RS-485 links, Controller-Area Network (CAN) links, and the like.

The administrator 120 may comprise any person, business or entity capable of performing and administering the methods disclosed herein. In one embodiment, the administrator 120 is an entity hosting an accessible server and a database 122. The server may comprise any type of computing device suitable for embodiments of the present invention. The server may be located at the administrator 120 physical site or at a remote location accessible via the network 160.

The database 122 may include a number of records in accordance with embodiments of the present invention, including data and/or other information, which may be parsed and stored. The database 122 may further comprise software, which may include and/or employ one or more database management systems (“DBMS”), such as any one of an Oracle, DB2, Microsoft Access, Microsoft SQL Server, Postgres, MySQL, 4th Dimension, FileMaker and Alpha Five DBMS, and the like. The DBMS may be operable to query the database 122, parse the information into the records, execute rules for sorting the information parsed into the records, execute rules for performing operations (e.g., mathematical, statistical, logical, etc., operations) on the information parsed into the records, and the like.

In many embodiments, the database software may be operable to apply the data from records into one or more models to form one or more output records. These output records include information that may be used to facilitate the bartering methods as disclosed herein. In addition, the database software may be operable to interface with web-server software, to allow manipulation of the database 122 via one or more web pages available to the administrator 120 via the network 160.

Optionally, the system 100 may also comprise a third party financial institution 150. The financial institution 150 may comprise a bank, a credit-based company, or the like, suitable for facilitating the financial transactions within the system. In one embodiment, the financial institution comprises a web-based payment system, for example, PayPal®.

In accordance with many embodiments of the present invention, each of the parties associated with the system 100 comprise the necessary electronic devices, having platforms and databases where applicable, to execute the methods as set forth by embodiments of the present invention. Alternative system architectures are contemplated by embodiments of the present invention provided such alternative architectures are capable of executing the various methods disclosed herein.

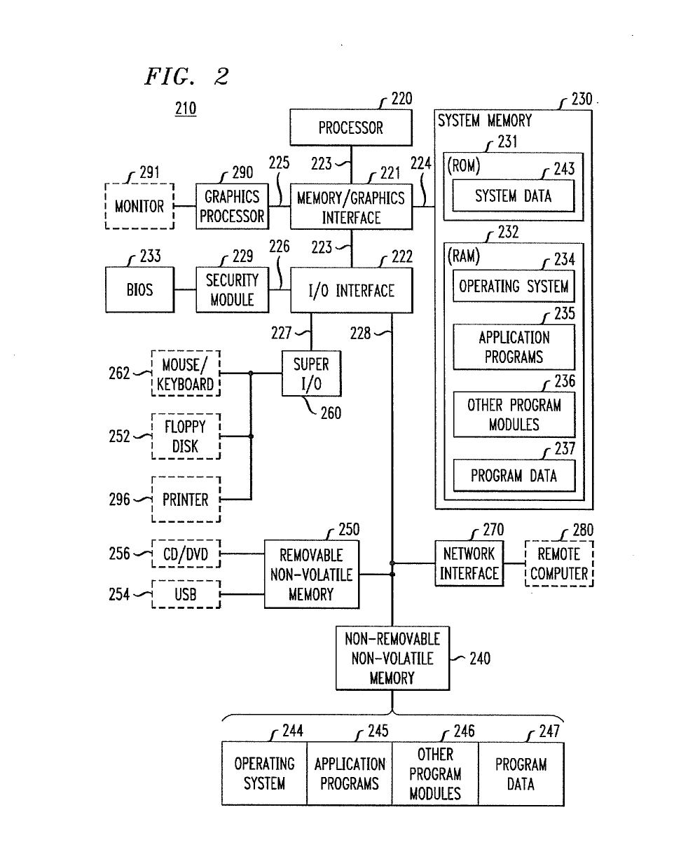

In several embodiments, the electronic device associated with each of the parties within the system comprises a general purpose computer system, for example, the general purpose computer system of FIG. 2. It should be appreciated, however, the general purpose computing system of FIG. 2 is merely an exemplary embodiment of an electronic device, and actual electronic devices may comprise any one or more components shown in FIG. 2, suitable for embodiments of the present invention.

With reference to FIG. 2, a general purpose computer system in the form of a computer 210 is shown. As understood by embodiments of the present invention, components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and can accessed by the computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other buses 226, 227 and 228 that couple a variety of internal and external devices to the computer 210. A serial peripheral interface (SPI) bus 226 may connect to a BIOS memory 233 containing the basic routines that help to transfer information between elements within computer 210, such as during start-up.

In some embodiments, a security module 229 may be incorporated to manage metering, billing, and enforcement of policies.

A super input/output chip 260 may be used to connect to a number of ‘legacy’ peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 252 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media, discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different elements within the computer 210. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), an Ethernet-based network, a wide area network (WAN), or both, but may also include other networks. Such networking environments are commonplace in offices, enterprise-wide computer networks, intranets, and the Internet.

It should be appreciated by embodiments of the present invention, execution of the methods and functions described herein with respect to the network may be executed by not only a physical computing device, for example, as shown in FIG. 2, but also on a virtual machine. Accordingly, although many physical elements are disclosed herein, the virtual equivalent of such elements may be implemented on a virtual platform without any deviation from the methods and functions disclosed herein.

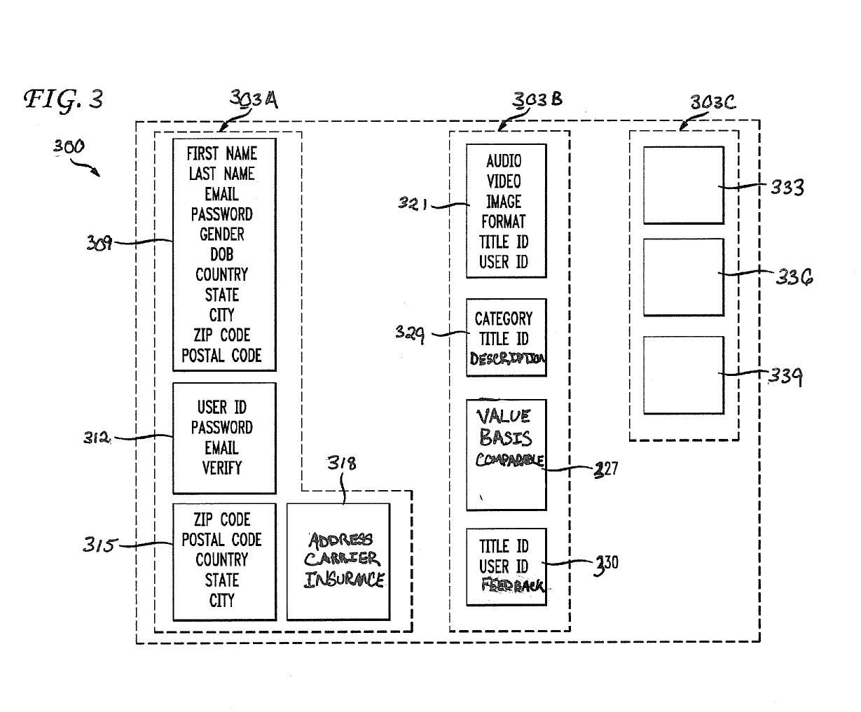

FIG. 3 illustrates a block diagram of a database and data sets utilized in accordance with embodiments of the present invention. Database 300 generally includes data categories 303, e.g., 303A-C, that are further organized into data groups, e.g., user data 309, profile data 312, location data 315, shipping data 318, multimedia data 321, barterable entry data 329, value data 327, feedback data 330, among others. A suitable database 300 may comprise any database suitable to manage, organize, and categorize the information that is collected from the users of the system. A detailed listing of common suitable databases is provided above with respect to database 122 of FIG. 1, and for purposes of this disclosure, the discussion herein with respect to database 300 may be equally applied to the database 122.

Although only specific examples of data categories 303 are show in the embodiment of database 300 in FIG. 3, it will be appreciated by those having ordinary skill in the art, any number of categories and groups are available for use in database 300. Thus, the illustration of database 300, and the discussion herein, should not limit in anyway the scope and spirit of the present disclosure. Rather, database 300 is described herein as one example of the way the information within the system is implemented in accordance with concepts of the present invention.

Information found in database 300 is identified in accordance with each individual user of the system. It may be linked together into cohesive units, such as, for example, user accounts, corporate accounts, and other types accounts that the information in database 300 to the users of the interactive portal. In the present example, data groups are configured in a manner that organizes the information into individual user accounts. These include information that is entered by the users via a user interface or other collection method, e.g., via telephone, electronic mail, postal mail, or the like.

Data groups include several categories of information as introduced above. Generally, in the embodiment shown, each of the data categories 303 represent a different type of data stored within the database 300. For example, data category 303A may comprise general user account information, data category 303B may comprise barterable entry information and data category 303C may comprise miscellaneous data, for example, social networking features, preferences, or the like, to be utilized within the system.

In considering the user account information 303A, user data 309 may generally comprise a set of information provided by the user of the system upon initial use or “signing up” with the system. Generally, such information may include name (e.g., first and surname, business entity name, etc.), location information (e.g., residential address, business address, virtual/electronic address, etc.), and other information may not be likely to change over the course of use with the system. Profile data 312 may generally comprise information specific to the user's account, also provided during an initial use of the system. Such information may include user name, password, verification steps, and the like.

Location data 315 may likely include information regarding where the user may seek to have goods shipped, services performed, of the like. For many corporate entities, a warehouse location may be a preferred location for shipment, whereas contact information may an office address. Accordingly, information regarding where bartering transactions may occur will generally be obtained. Similarly, shipping data 318 may include preferred shipping carriers, insurance information, or the like.

Exemplary barterable entry information is usually stored within data category 303B. As described hereinbelow, a user may upload data regarding a barterable entry, including multimedia data 321. Multimedia data 321 may comprise any type of multimedia data, including audio, photographs, illustrations, videos, or the like, in connection with the barterable entry. Similarly, descriptive barterable entry data 329 may be provided. Such descriptive barterable entry data may generally comprise a written description of the barterable entry, a generalized categorization (e.g., automotive, professional services, music, etc.), or any other information, in combination with the multimedia data 321, that may be useful for enabling a third party to understand and appreciate the barterable entry.

In many embodiments of the present invention, a user may be required to assess a point value of the barterable entry and provide such point value as value data 327. A description of how such barterable entry point value is determined is provided below. In addition to just a point value, however, a user may provide information regarding the basis for such point value, including for example, comparable point values of other barterable entries within the system.

In many embodiments, feedback data 330 may comprise data provided by other users about the one particular user who is providing the barterable entry or about the barterable entry itself. Such types of postings, ratings, comments and the like are generally known to one of ordinary skill in the art.

The miscellaneous data category 303C may comprise any other data items related to operating components of the exemplary system disclosed herein. For example, such other data items include preferential content data 333, message data 336, bulletin board data 339 or the like. Preferential content data 333 may refer to data that describes the preferences that the users of the system have with respect to one another, and with respect to their individual account settings. In other embodiments, any type of social networking data may be stored under the miscellaneous data category 303C, for example, chat functions, and profile information (e.g., profile pictures, introductory information, or the like.) In accordance with further embodiments of the present invention, the miscellaneous data category may store any type of data required by the system to operate, not already set forth herein.

In certain embodiments, information stored in the database 300 may be imported, uploaded or otherwise obtained from a third party source. For example, in one embodiment, the miscellaneous data category 303C may include data imported from a social networking profile (e.g., FaceBook, MySpace, LinkedIn, etc.), and may provide any type of information generally stored in such a profile (e.g., wall posts, friend lists and contact information, or the like). In other embodiments, data may be imported from any third party or external source, including for example, email contacts, telephone contacts, corporate website information, or the like.

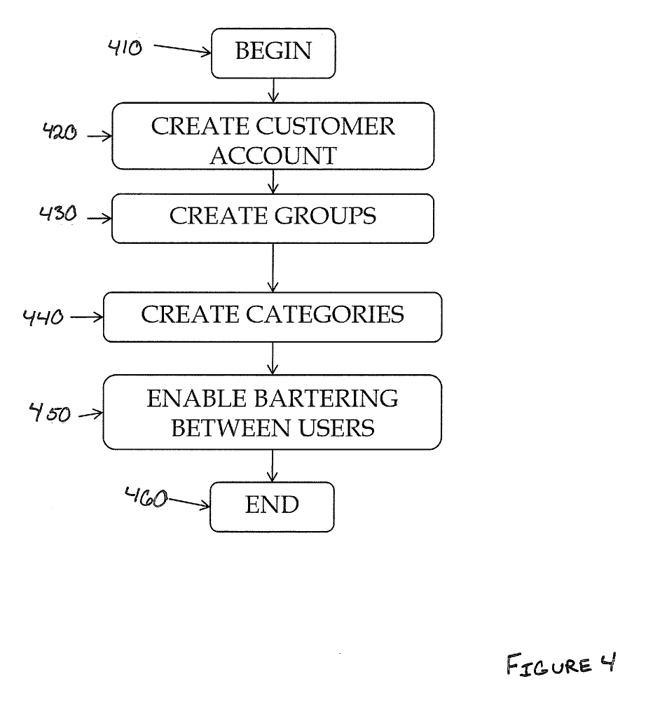

FIG. 4 depicts a general flow chart of a method of administering a bartering system, in accordance with one exemplary embodiment of the present invention. FIG. 4 may be described generally in relation to system depicted in FIG. 1. The method 400 starts at step 410 where a system, such as the system 100 of FIG. 100 is provided. At step 420, an administrator creates a customer entity account. In one embodiment, the creation of the consumer entity comprises the establishment of an account within the database 122.

Generally, where an account is created on the database 122 for a customer 110, information is gathered from the customer during a “registration” page, accessible via the global computer network. For example, in one embodiment, a customer 110 may provide certain information relating to unique characteristics of the customer 110, e.g., demographic information, financial information, personal information, geographical information, or the like as described above. In certain embodiments, when creating the customer account, the administrator 120 may classify and/or categorize the customer into one or more of several plausible groups. Such types of groups may be based on occupations, interests, or the like, as provided by the client.

At step 430, the administrator may optionally create organized user groups within the system 100. As understood by embodiments of the present invention, a user group generally comprises an exclusive network of users managed by a group owner (e.g., a “virtual community”) or the administrator 120 (e.g., an “affinity group”). As mentioned above, in many embodiments, the user groups may be created by the administrator based on particular occupations, interests or other common-type characteristics between a plurality of customers. In some embodiments, the groups may be generally “public,” such that any customer may obtain entry into the group, either subject to no requirements or subject to particular extant criteria (e.g., location, industry, or the like).

In many embodiments, the user groups may be limited or restricted, such that requests to join the group are subject to review by a group owner or the administrator 120. Often, user groups may be formed upon requests from users who wish to be group owners. In such embodiments, user group formation may occur similar to social networking “friends” such that group owners receive requests from or send invitations to other users in order to join certain groups and create “virtual communities.” In an alternative embodiment, certain limited user groups may be formed through the importation of third party data, i.e., the user group may be formed by all or some of a user's “friends” on a third party social networking site. As appreciated by embodiments of the present invention, by utilizing the importation of data from third party sources, privatized user groups can be created based upon prior relationships between multiple users.

In accordance with embodiments of the present invention, the administrator 120 may generally have the ability to create user groups, add a group owner, modify the group owner, delete user groups, or the like.

At step 440, the administrator may create and/or manage categories of the goods and services to be bartered within the system. In accordance with embodiments, of the present invention, any plausible type of category listing, or combination thereof, is suitable for embodiments of the present invention. For example, categories of goods and services may include automobiles, electronics, tickets, clothing, legal services, automotive services, or the like. The administrator 120 may add, delete or modify categories as it deems necessary, and may update a search tool for ease of usability within the various categories or across all categories.

In accordance with embodiments of the present invention, similar to the group formations, the categories of goods and services may be utilized to facilitate the pairing of like users for purposes of finding a suitable bartering partner. In most embodiments, however, the categories exist independent of the user groups (i.e., within all groups, public or restricted, the categories may be utilized to describe the goods or services of all users). In certain embodiments, the categories may be restricted upon verification of an attribute or characteristic of the good or service being offered. For example, in a “legal services” category, the system 100 may require an attorney, with proof of admission to a state bar, be the only profession allowed to list services within such category. Similarly, in a group entitled “autographed sports memorabilia,” certain trade-recognized indicia of authenticity may be required before a good is allowed to be listed in such user group. As such, in accordance with some embodiments, categories may be limited within certain groups or unique to a certain user group.

Optionally, a user group owner may limit the types of categories within the group, such that all goods or services being bartered within the group pertain to the groups' limiting purposes. Similarly, a user group owner may optionally limit a member of the user group's ability to post items for barter within the group.

At step 450, the administrator 120 may enable users to barter within the system 100. In many embodiments, the administrator may establish a point/credit system for users to determine a point value for all goods or services being offered for barter within the system 100. In one embodiment, the administrator 120 may establish a basis or guidelines for determining the value of a single point or unit of point value for use within the system.

For example, a unit of point value may be equivalent to any medium of exchange, which may or may not have some intrinsic value (e.g., gold) or recognized value (e.g., fiat money, such as currency). Examples of media of exchange include currency (e.g., USD, EUR, JPY, CHF, GBP, HKD, or the like), combinations of currencies (e.g., USD and EUR, JPY and CNY, or the like), tokens (such as credits in a third party business), any other medium of exchange feasible in accordance with embodiments of the present invention, or any combination thereof.

In one exemplary embodiment, each user may assess a point value of a barterable entry in view of a predetermined standard for the relative worth of a unit of point value. In such an embodiment, a unit of point value for a first user may have a different worth than that of a second user. Accordingly, because the nature of a barter system often requires a subjective assessment of the wants and needs of each entity therein, allowing a user to assess its own point value on an individual basis allows users to accommodate such intrinsic value the user may place on its barterable entry. However, in many embodiments, such unit of point value designation may be subject to validation or approval by the administrator 120 and/or a group owner, if such posted barterable entry is within a particular group.

In many embodiments, by establishing a point value system, users who wish to barter with one another for random goods may be able to gauge a value for the respective bartered goods. In many embodiments, where users live in different countries or regions of the world, and utilize different currency, such a point system is highly advantageous.

In some embodiments, a user may be allowed to purchase additional points from the administrator 120, and may subsequently utilize the points for bartering. For example, a first user may have a first good and wish to barter with a second user with a second good; however, the first good may have a lower point value than the second good. Even where both users wish to barter for the respective goods, the second user may demand something additional to effectively counterbalance the discrepancy in point values. If the first user does not have an additional good to offer, the first user may use his or her available points or purchase points from the administrator in a cash transaction. The first user may then offer such points to the second user in order to satisfy the discrepancy in value. However, in many embodiments, the point values are not required to be equal for the transaction proceed; rather, it is merely optional and a means for which users may gauge and assess transactions.

In many embodiments, the points have no cash or monetary value outside of the virtual marketplace created by the system, despite being available for purchase in certain embodiments and/or being equivalent to a particular medium of exchange. As such, once additional points are created within the system 100, such points may always remain in the system 100 and may be used in any number of bartering transactions. In one embodiment, a user in possession of such points may be allowed to barter the points for currency (i.e., sell the points).

In many embodiments, the administrator 120 may provide a desired function for each user, such that each user can store in its account, a listing of all goods or services that it may wish to barter for. By utilizing such a desire function, the administrator 120, through functional database software, may be able to more readily facilitate barter exchange between two parties by putting users in contact when each are in possession of a good or service “desired” by the other user.

As appreciated by various embodiments of the present invention, the administrator 120 may provide a plethora of additional services within the system 100 to facilitate the methods disclosed herein. In particular, the administrator 120 may implement substantial tiers of security and validation beyond those described above, as necessary for embodiments of the present invention. Examples of such type of security may include: user-rating systems to unlock or remove certain levels of access within the system, financial confirmation/validation from a user's financial institution, exchange and/or validation of codes generated by the administrator, proof of possession of certain goods or services, revocation of points and/or membership privileges by the administrator, or the like.

The method 400 ends at step 460.

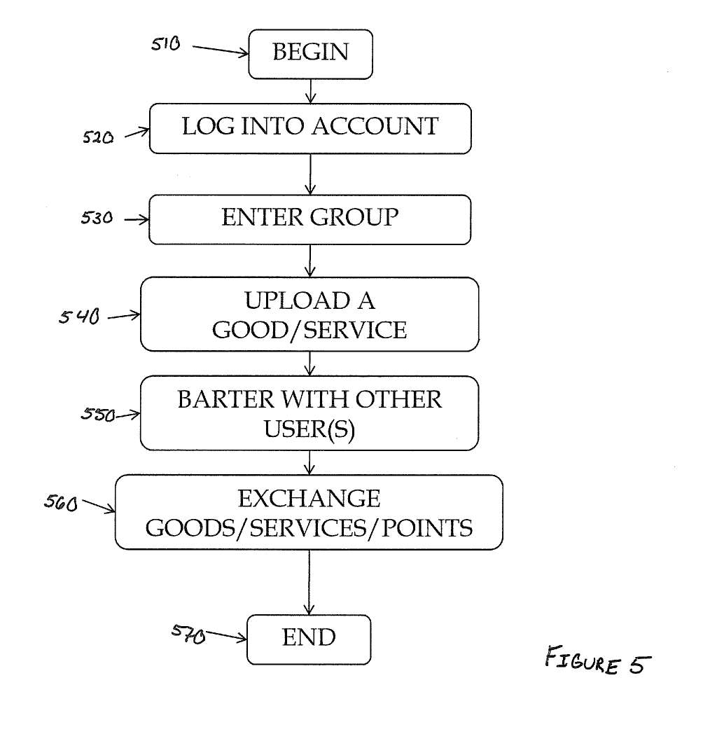

FIG. 5 depicts a general flow chart of one exemplary method for using a bartering system via a global computer network in accordance with one exemplary embodiment of the present invention. FIG. 5 may be described generally in relation to system depicted in FIG. 1. The method 500 begins with step 510. At step 520, a user may log into an account, generally hosted by the administrator 120. Upon validation by the administrator 120, the user may be directed to its account within the system 100.

In certain embodiments, a user may be required to register for an account prior to being able to log into the system. A user may have to provide certain contact (e.g., name, address, telephone, email, or the like) and login (e.g., user name, password, or the like) information to the system. Generally, a verification step may be utilized to verify the identity of the user prior to allowing registration with the system. The verification step may comprise any suitable verification means, including, but not limited to, a telephone confirmation, email confirmation, address search, manual confirmation by the administrator, credit check, fraudulent check, or the like.

In some embodiments of the present invention, a user is not required to log in before searching for goods and services. In such embodiments, a nonregistered user may browse goods and services without registering as a new user, although the scope of information available to such nonregistered users is greatly diminished.

Once logged into the user account, at step 530, the user may optionally enter a user group to engage one of any number of activities. For many embodiments, the user may belong to any number of user groups as exist within the system 100. As described above, groups may either be public (e.g., affinity groups) or restricted (e.g., virtual communities). In certain embodiments, a global user group may exist within the system 100, to which all users may belong by default.

If a user seeks to join an existing user group to which it is not a member, the user may submit a request to join the group. Such request may be readily accepted by virtue of particular credentials or characteristics of the user, or alternatively, admission to the user group may be dependent upon approval by the administrator 120, the group owner, or other responsible party.

In some embodiments, a user may wish to create a new virtual community user group based on certain characteristics, qualities, or the like. In such embodiments, a request may generally be submitted to the administrator 120 for approval. In certain instances, for example, if a user has a particularly high user rating, an approval process may be automated and expedited. When a new user group is created, the user requesting the new group may generally become the group owner. The group owner may invite users and non-users of the network to join the group, manage membership and posting ability of users in reference to the group, name the group, or the like.

In certain embodiments, as soon as a virtual community user group is established, information may be obtained from any third party source affiliated with the group owner. Such information may include, for example, a list of contact information for known colleagues, friends, family, etc. through the group owner's email contacts, social networking “friends,” or the like. Optionally, once such information is obtained, any of such contacts within the system may be added to the virtual community, or similarly, requests may be sent out to each member of the contacts to invite such person to join the virtual community user group within the system.

At step 540, a user may upload data regarding a barterable entry for bartering within the system. Whereas embodiments of the present invention occur within a virtual space, the uploading of data regarding a barterable entry generally includes providing a detailed description, photos, quality, quantity, or other characteristic of the good or service. In certain instances, a user may be required to provide authenticity (e.g., independent verification, certification, awards, etc.) of the quality or nature of the goods or services. Such authenticity may be desirable in the bartering of certain goods or services more susceptible to fraud or misrepresentation.

The user may often be required to place an estimated point value on the goods or services being uploaded, for example, as described above. In some embodiments, a group owner or the administrator 120 may either be required to authorize the good or service point value, or provide an approximate point value based on the description provided.

At step 550, the user is permitted to barter its barterable entry for one or more barterable entries of other users by utilizing the system 100 described herein. In one exemplary embodiment, a first user (i.e., barterer) may search globally for a good or service through a specified category (e.g., books, cars, etc.), or through a general search engine available from the administrator. When the barterer locates a desired good or service in possession of a second user (i.e., barteree), the barterer may make an offer to the barteree for such good or service by offering a good, service or number of points in possession of the barterer. The parties may negotiate back and forth over certain goods, services or points in the possession of each other until either an agreement can be reached, or one of the parties makes the decision to cease negotiations for futility, or preferred negotiations/agreement with another user.

In accordance with various embodiments, a user may make offers on numerous goods or services of any number of other users, by offering only one or more of such user's own goods, services, cash, or points. In such embodiments, as soon as the user comes to an agreement with another user for its goods, services, cash or points, the other ongoing negotiations may be automatically suspended by the administrator. For a limited time, the users' other ongoing negotiations may be continued using different goods, services, cash or points.

Embodiments of the present invention may allow for reverse barter requests, whereby a user may find a good or service desired in possession of another user, but may not have any goods or services to offer for bartering, or perhaps none readily available. In such embodiments, the user in possession of the desired good or service may be asked by the other user what it would accept for such good or service. Thus, the reverse barter request is akin to an invitation to make an offer, rather than an actual offer on its own.

In certain other embodiments, it may be desirable to engage in a group barter (e.g., User A has Good X, User B has Good Y, and User C has Good Z; and whereby, User A desires Good Y, User B desires Good Z, and User C desires Good X). In combination with a desire function, as described above, such group barter may be facilitated by the administrator where each of Users A, B and C are automatically suggested by the system to engage in a group barter. Although such group barter may occur through three separate transactions (i.e., User A to User B, User B to User C, User C to User A), embodiments of the present invention may allow for a single transaction to occur upon acceptance by all parties involved. Such types of group bartering may be limited to within a particular group, or may be adapted for all users.

At step 560, after an agreement has been reached between a first user (e.g., barterer) and a second user (e.g., barteree), the parties exchange the goods, services or points with one another. Generally, the actual exchange of goods or services occurs outside the scope of the system 100 and the administrator 120. For example, exchanges may include the utilization of third party courier and parcel services (e.g., FedEx, UPS, USPS, DHL or the like), the face-to-face delivery of services (e.g., repairing a user's lawnmower may require the users meet in person), or the like. In certain instances, where points that have been purchased from or awarded by the administrator are involved in the transaction, the administrator may hold the points in trust until all services have been rendered and complete and/or all goods have arrived safely in good form. As contemplated herein, any transfer medium or means including the exchange/validation of administrator generated codes as well as the withholding or revocation of points may be suitable for the various embodiments of the present invention.

The method 500 ends at step 570.

Beyond the specific methods and architectures disclosed herein, it should be appreciated that embodiments of the present invention may further comprise additional components, methods, or entities, provided such unique business processes as disclosed herein, are maintained. For example, the system 100 of embodiments of the present invention may comprise a plethora of additional features, for example, social networking features. As such, it should be appreciated that embodiments of the present invention may include: user-personalized webpages, chat/email functions, the ability to import and/or create a group from an existing contact list (e.g., Microsoft Outlook contacts) or an existing social networking group (e.g., Connections on LinkedIn.com), extending access to mobile and other devices, or the like.

While the foregoing is directed to embodiments of the present invention, other and further embodiments of the invention may be devised without departing from the basic scope thereof. Specifically, embodiments of the present invention are further scalable to allow for additional clients and servers, as particular applications may require.

What is claimed is:

1. A system for enabling bartering between third parties, the system comprising:
an administrator comprising a host computer, accessible via a global computer network, the host computer comprising a tangible computer readable medium comprising program instructions, wherein the program instructions are computer-executable to implement:
allowing a first user to upload a first set of data to the host server regarding a first barterable entry;
enabling the first user to assess a point value of the first barterable entry;
allowing a second user to upload a second set of data to the host server regarding a second barterable entry;
enabling the second user to assess a point value of the second barterable entry; and
enabling the first user to barter with the second user, wherein the first user seeks to obtain the second barterable entry in exchange for the first barterable entry;
the first user comprising a first computer device, capable of communicating with the host server through the global computer network; and
the second user comprising a second computer device, capable of communicating the host server through the global computer network.

2. The system of claim 1, wherein the first and second barterable entries may each comprise a good, a service, a unit of point value, or combinations thereof.

3. The system of claim 2, wherein the first and second set of data each respectively comprise descriptive information regarding the first and second barterable entry.

4. The system of claim 1, wherein enabling the first user to assess a point value of the first barterable entry comprises allowing the first user to determine the point value of the first barterable entry in view of a predetermined standard for the relative worth of a unit of point value.

5. The system of claim 1, further comprising:
a third user comprising a third computer device, capable of communicating with the host server through the global computer network, the third user further comprising a third set of data for submitting to the host server regarding a third barterable entry.

6. The system of claim 1, wherein the first, second and third computer devices may each comprise any one of a personal computer, a mobile computer, a laptop computer, a smartphone, a netbook, or a mobile telephone.

7. The system of claim 1, wherein the program instructions are computer-executable to further implement:
allowing the first user to create a first user group; and
allowing the second user to become a member of the first user group.

8. A method of enabling bartering between third parties comprising:
providing a host computer, accessible via a global computer network;
allowing a first user comprising a first computer device, capable of communicating with the host server through the global computer network, to upload a first set of data to the host server regarding a first barterable entry;
allowing a second user comprising a second computer device, capable of communicating with the host server through the global computer network, to upload a second set of data to the host server regarding a second barterable entry;
allowing the first user to determine the point value of the first barterable entry in view of a predetermined standard for the relative worth of a unit of point value;
allowing the second user to determine the point value of the second barterable entry in view of a predetermined standard for the relative worth of a unit of point value; and
enabling the first user to barter with the second user, wherein the first user seeks to obtain the second barterable entry in exchange for the first barterable entry.

9. The method of claim 8, wherein the first and second barterable entries may each comprise a good, a service, a unit of point value, or combinations thereof.

10. The method of claim 9, wherein the first and second set of data each respectively comprise descriptive information regarding the first and second barterable entries.

11. The method of claim 8, further comprising:
allowing a third user comprising a third computer device, capable of communicating with the host server through the global computer network, to upload a third set of data to the host server regarding a third barterable entry.

12. The method of claim 8, wherein the first and second computer devices may each comprise any one of a personal computer, a mobile computer, a laptop computer, a smartphone, a netbook, or a mobile telephone.

13. The method of claim 8, further comprising:
allowing the first user to create a first user group; and
allowing the second user to become a member of the first user group.

14. A method of enabling bartering between third parties comprising:
allowing a first user comprising a first computer device, capable of communicating with a host server through a global computer network, to upload a first set of data to the host server regarding a first barterable entry;
allowing a second user comprising a second computer device, capable of communicating with the host server through the global computer network, to upload a second set of data to the host server regarding a second barterable entry;
allowing the first user to determine the point value of the first barterable entry in view of a predetermined standard for the relative worth of a unit of point value;
allowing the second user to determine the point value of the second barterable entry in view of a predetermined standard for the relative worth of a unit of point value;
receiving a request from the first user regarding a desire to obtain the second barterable entry;
receiving a response from the second user regarding the request; and
enabling the first and second users to barter the first barterable entry for the second barterable entry, respectively.

15. The method of claim 14, wherein the first and second barterable entries may each comprise a good, a service, a unit of point value, or combinations thereof.

16. The method of claim 15, wherein the first and second set of data each respectively comprise descriptive information regarding the first and second barterable entries.

17. The method of claim 14, further comprising:
allowing a third user comprising a third computer device, capable of communicating with the host server through the global computer network, to upload a third set of data to the host server regarding a third barterable entry.

18. The method of claim 14, wherein the first and second computer devices may each comprise any one of a personal computer, a mobile computer, a laptop computer, a smartphone, a netbook, or a mobile telephone

19. The method of claim 14, wherein the first user and the second user comprise respective user accounts, the user accounts being stored within a virtual bartering marketplace on a memory device within the host computer.

20. The method of claim 14, further comprising:
allowing the first user to create a first user group;
importing data from a third party source affiliated with the first user regarding at least a second user;
allowing the second user to become a member of the first user group.
